(19) United States
(12) Patent Application Publication
(10) Pub. No.: US 2024/0224899 A1
(43) Pub. Date: Jul. 11, 2024

(54) DRIPPER WITH ANTIMICROBIAL COATING

(71) Applicant: N-Drip Ltd., Kfar Saba (IL)

(72) Inventors: Zvi MILLER, Kiryat-Tivon (IL); Uri Avraham SHANI, Tel-Aviv (IL); Sharon DABACH, Tel-Aviv (IL)

(73) Assignee: N-Drip Ltd., Kfar Saba (IL)

(21) Appl. No.: 18/269,778

(22) PCT Filed: Dec. 28, 2021
(86) PCT No.: PCT/IL2021/051542

§ 371 Date: Jun. 27, 2023

Related U.S. Application Data
(60) Provisional application No. 63/132,534, filed on Dec. 31, 2020.

(51) Int. Cl. A01G 25/02

(52) U.S. Cl. CPC A01G 25/02

(57) ABSTRACT

An irrigation dripper comprising a generally straight water pathway for allowing a two-dimensional or a three-dimensional flow of water therein, an inlet for providing water to said pathway, an outlet for allowing water to drip out of said pathway at an angle to said pathway, and an antimicrobial coating at least partially surrounding said inlet.

### RELATED APPLICATION

This application claims the benefit of priority of U.S. Provisional Patent Application No. 63/132,534 filed on Dec. 31, 2020, the contents of which are incorporated herein by reference in their entirety.

### FIELD AND BACKGROUND OF THE INVENTION

The present invention, in some embodiments thereof, relates to an irrigation dripper and, more particularly, but not exclusively, to an irrigation dripper with antimicrobial coating.

Drip irrigation is a watering method that utilizes pressurized water sources and drips water along a distribution pipe in a controlled manner. Drip irrigation systems are considered to be more efficient than surface irrigation systems that typically distribute water in the fields by runoff. Surface irrigation systems require smaller investment and lower energy costs, and these systems typically employ high discharge at the inlet in order to irrigate efficiently and uniformly across a field so that water will reach the end of the field.

In drip irrigation system, drippers are inserted into or mounted onto a water supply line typically at regular intervals. Examples of drippers for drip irrigation system are described in International publication Nos. WO2017/191640 and WO2019/092717, the contents of which are hereby incorporated by reference. These publications describe a dripper with a pathway that is not one-dimensional and that allows bypass routes around obstacles that may be inside the dripper.

### SUMMARY OF THE INVENTION

According to an aspect of some embodiments of the invention there is provided an irrigation dripper comprising a generally straight water pathway for allowing a two-dimensional or a three-dimensional flow of water therein, an inlet for providing water to the pathway, an outlet for allowing water to drip out of the pathway at an angle to the pathway, and an antimicrobial coating at least partially surrounding the inlet. According to some embodiments of the invention the outlet is generally perpendicular to the pathway. According to some embodiments of the invention the outlet forms an acute angle to the pathway.

According to some embodiments of the invention the irrigation dripper comprises: an external elongated hollow structure enclosing an internal elongated structure, wherein the water pathway surrounds the internal structure in a space between the structures.

According to some embodiments of the invention the irrigation dripper comprises: an external elongated hollow structure having a rigid wall and a flexible wall, and an internal elongated structure introduced into the external structure, wherein the pathway is formed between the internal structure and the walls. According to some embodiments of the invention the flexible wall is generally planar in the absence of pressure difference between an inner side and an outer side thereof. According to some embodiments of the invention the flexible wall is curved in the absence of pressure difference between an inner side and an outer side thereof.

According to some embodiments of the invention the inlet is on a face of the external structure, the outlet is on the external structure, and the antimicrobial coating is on the face of the external elongated hollow structure, but not within the pathway.

According to some embodiments of the invention the antimicrobial coating is inorganic.

According to some embodiments of the invention the antimicrobial coating is metallic.

According to some embodiments of the invention the antimicrobial coating comprises copper.

According to some embodiments of the invention the antimicrobial coating comprises copper.

According to some embodiments of the invention the antimicrobial coating comprises a partially melted powder.

According to some embodiments of the invention the powder comprises particles less than 80 microns in diameter.

According to some embodiments of the invention at least 99% of the particles are less than 80 microns in diameter.

According to some embodiments of the invention at least 95% of the particles are less than 40 microns in diameter.

According to some embodiments of the invention the face of the external elongated hollow structure is spray coated by the antimicrobial coating.

According to some embodiments of the invention the spray coating is cold spray coating. According to some embodiments of the invention the spray coating is thermal spray coating.

According to some embodiments of the invention the face of the external elongated hollow structure is dip coated by the antimicrobial coating.

According to an aspect of some embodiments of the present invention there is provided an irrigation dripping pipe, comprising an irrigation pipe provided with a plurality of drippers, wherein at least one of the drippers is the irrigation dripper as delineated above and optionally and preferably as further detailed below.

According to some embodiments of the invention the irrigation pipe has a first end connectable to a water source or a water distribution line, and second end distal to the first end, and wherein for at least one of the drippers, the inlet is facing the second end such that an inflow of water into the at least one dripper is opposite to a flow of water in the irrigation pipe.

According to an aspect of some embodiments of the present invention there is provided a method of irrigation, the method comprising deploying the irrigation dripping pipe in a field, and supplying water to the irrigation dripping pipe.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D illustrate an exemplified irrigation dripper according to some embodiments of the present invention, where FIG. 1A illustrates a cross-sectional view of the irrigation dripper once assembled, FIG. 1B illustrates a cross-sectional view of the irrigation dripper before assembling, and FIGS. 1C-D illustrate perspective view of the irrigation dripper once assembled;

FIGS. 2A-D are schematic illustrations of a flow regulated irrigation dripper, according to some embodiments of the present invention;

FIGS. 3A and 3B are cross-sectional schematic illustrations of a dripper within a pipe, in a plane perpendicular to the longitudinal axis of the pipe, according to some embodiments of the present invention;

FIGS. 4A and 4B are schematic illustrations of a dripper in embodiments of the invention in which a flexible wall is made of the same material as a rigid wall, except at a smaller thickness; and

FIGS. 5A and 5B are schematic illustrations showing a typical use of the irrigation dipper, according to some embodiments of the present invention.

### DESCRIPTION OF SPECIFIC EMBODIMENTS OF THE INVENTION

The present invention, in some embodiments thereof, relates to an irrigation dripper and, more particularly, but not exclusively, to an irrigation dripper with antimicrobial coating.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

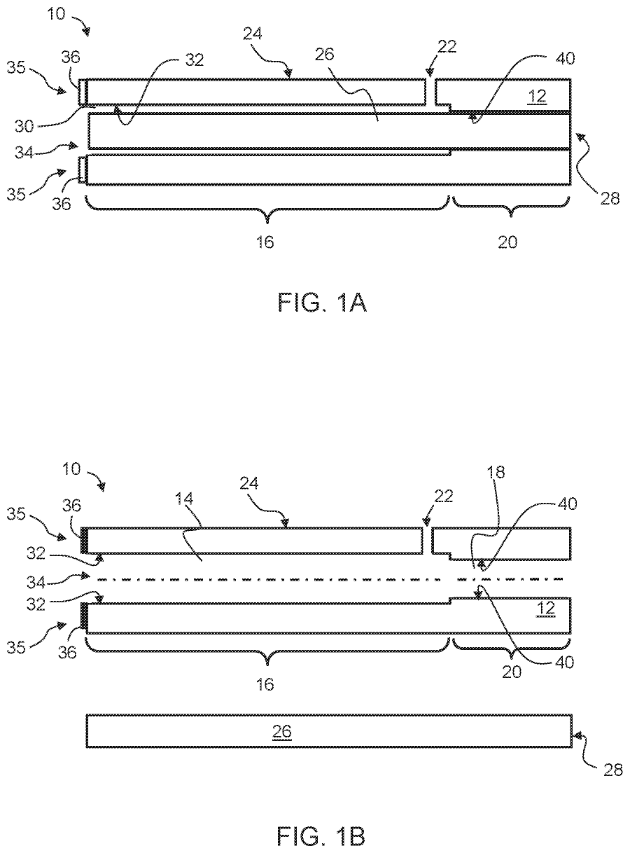

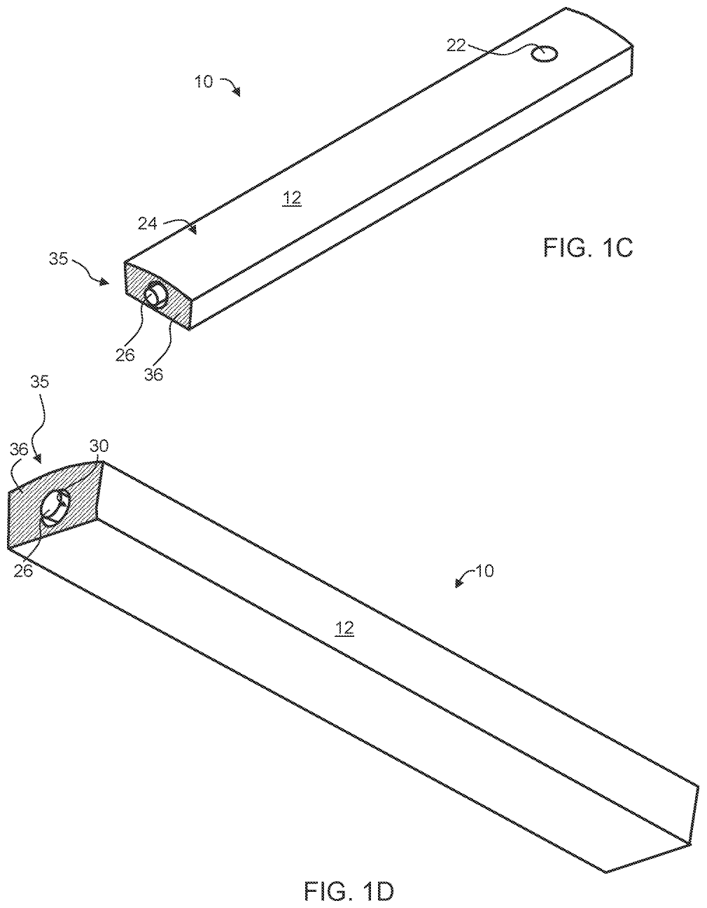

FIGS. 1A-D. 2A-D, and 4A-B of the drawings illustrate an exemplified irrigation dripper 10 that can be fabricated according to some embodiments of the present invention.

Referring firstly to FIGS. 1A-D, FIG. 1A illustrates a cross-sectional view of irrigation dripper 10 once assembled, FIG. 1B illustrates a cross-sectional view of irrigation dripper 10 before assembling, and FIGS. 1C-D illustrate perspective view of irrigation dripper 10 once assembled.

Dripper 10 comprises an external elongated hollow structure 12, having therein a first longitudinal bore 14 along a first segment 16 of external elongated hollow structure 12, and a second longitudinal bore 18 along a second segment 20 of structure 12, wherein second bore 18 is contiguous to first bore 14 and smaller in diameter than first bore 14.

The term “longitudinal bore”, as used herein, means a bore drilled along a longitudinal direction.

Herein, the longitudinal direction is defined as a direction along the largest dimension of external elongated hollow structure 12, and the radial direction is defined as a direction perpendicular to the longitudinal direction.

A typical diameter of bore 14 is from about 0.5 mm to about 5.5 mm, e.g., about 2.5 mm.

A typical length of bore 14 is from about 5% to about 95%, more preferably from about 20% to about 95% more preferably from about 40% to about 95% more preferably from about 60% to about 95% more preferably from about 80% to about 95% of the length of structure 12.

A typical diameter of bore 18 is from about 0.3 mm to about 5 mm, e.g., about 2.4 mm.

A typical length of bore 18 is from about 5% to about 95%, more preferably from about 5% to about 80% more preferably from about 5% to about 60% more preferably from about 5% to about 40% more preferably from about 5% to about 20% of the length of external elongated hollow structure 12.

A typical length of external elongated hollow structure 12 is from about 5 mm to about 65 mm, e.g., about 25 mm.

Structure 12 can be a round body with typical diameter from about 3 mm to about 20 mm. Elongated body can be a rectangle with dimensions from about 2×3 mm to about 3×10 mm. Elongated body can be a square shape with dimensions from about 2×2 mm to about 10×10 mm.

The outer surface 24 of external elongated hollow structure 12 can have any shape, including, without limitation, a cylinder, or a prism (e.g., a triangular prism, a parallelepiped, a square cuboid, a rectangular cuboid etc.). In the schematic illustrations in FIGS. 1C and 1D, which are not to be considered as limiting, structure 12 has a shape which resembles a rectangular cuboid, except that its upper faces has a curvature.

One or more outlets 22 (only one is illustrated in FIGS. 1A-C) are formed in external elongated hollow structure 12 to connect the outer surface 24 with bore 14. Outlets 22 is/are at an angle to the longitudinal direction. In some embodiments of the present invention at least one of outlets 22 extends along the radial direction, and is referred to herein as a “radial outlet.”

A typical diameter of outlet 22 is from about 0.5 mm to about 10 mm, more preferably from about 1 mm to about 10 mm.

Irrigation dripper 10 also comprises an internal elongated structure 26 that, once dripper 10 is assembled, extends along both bores 14 and 18, in a manner that the inner wall 40 of second bore 18 holds a distal end 28 of internal elongated structure 26 to maintain a pathway 30 between internal elongated structure 26 and an inner wall 32 of first bore 14. Dripper 10 comprises an inlet 34 for providing liquid (e.g., water) to pathway 30, wherein outlet 22 allows the liquid to drip out of pathway 30. According to some embodiments of the invention outlet 22 is generally perpendicular to pathway 30. According to some embodiments of the invention outlet 22 forms an acute angle with pathway 30.

Internal elongated structure 26 can have any shape, including, without limitation, a cylinder, or a prism (e.g., a triangular prism, a parallelepiped, a square cuboid, a rectangular cuboid etc.). In the schematic illustrations in FIGS. 1C and 1D, which are not to be considered as limiting, internal elongated structure 26 has a cylindrical shape.

Dripper 10 also comprises an antimicrobial coating 36 which is made of, or comprises, an antimicrobial material, and which at least partially surrounds inlet 34 on a face 35 of external elongated hollow structure 12 in which inlet 34 is formed, but not within pathway 30.

The term “antimicrobial material” as used herein includes agents capable of killing microorganisms, blocking or preventing microbial contamination (such as a forming a barrier), or suppressing or preventing growth of microorganisms, trapping microorganisms for killing, or preventing biofilm formation.

Antimicrobial coating 36 is preferably selected to reduce or inhibit accumulation of a fouling biofilm at inlet 34, wherein the biofilm may include one or more of the microorganisms selected from the group consisting of bacteria, fungi, algae and archaebacteria. Antimicrobial coating 36 is preferably selected to reduce or inhibit growth of biofilm including two or more microorganisms.

In some embodiments of the present invention the antimicrobial material in antimicrobial coating 36 is inorganic. For example, the antimicrobial material in antimicrobial coating 36 can be made of a metal, such as, but not limited to, copper, zinc, bismuth and the like. Preferably the metal comprises copper, more preferably the metal that is pure copper. Also contemplated are metal halides, such as, but not limited to, copper halides, and/or metal salts, such as, but not limited to, copper salts, preferably insoluble copper salts. The biological activity of copper is to a large part due to its ability to exist in what is termed the free state as metallic copper or ionic state as a copper salt or oxide. A copper in a free or ionic state, is biologically active and is able to kill bacteria, viruses and fungi.

In some embodiments of the present invention the antimicrobial coating 36 (e.g., the copper) comprises a antimicrobial material in the form of a partially melted powder. The advantage of using antimicrobial coating 36 which is a partially melted powder, is that it creates a slow release effect, wherein each time a portion of the particles in the powder is released and inhibits growth of biofilm at inlet 34. For example, when the power is a metal (e.g., copper), the released particles are oxidized and destroy microorganisms, algae, or other organic material that may be present in the liquid outside dripper 10 at the vicinity of inlet 34. Since the coating is in the form of particles, the release occurs only during irrigation, thereby prolonging the duration at which coating 36 is effective.

In use of dripper 10 during irrigation, the antimicrobial material diffuses to the water flowing in dripper 10, and optionally and preferably to water contacting the external surface of dripper 10 from coating 36. The diffused material kills any microorganism that colonies or otherwise occupies the face 35 and optionally and preferably also on the outer surface 24. When the antimicrobial material is metallic (e.g., copper), the metal interacts with the water and oxidizes, wherein the microorganism is killed by the oxidized metal (e.g., oxidized copper).

Preferably, the powder comprises particles less than 80 microns in diameter. More preferably at least 99% of said particles are less than 80 microns in diameter. More preferably, at least 95% of said particles are less than 40 microns in diameter.

The advantage of having the antimicrobial coating 36 on a face of external elongated hollow structure 12 at which the inlet 34 is formed is that it prevents entry of biological material, such as bacteria, and formation of biofilm with pathway 30. Such biofilm may potentially block pathway 30 peripherally, and prevent or reduce flow of liquid in pathway 30. The advantage of ensuring that antimicrobial coating 36 remains external to structure 12 and is not applied within pathway 30, is that the coating 36 itself may potentially block pathway 30 and prevent or reduce flow of liquid in pathway 30. In some embodiments of the present invention following the application of coating 36, pathway 30 is drilled or re-drilled, so as to ensure that no remnant of the coating is in pathway 30.

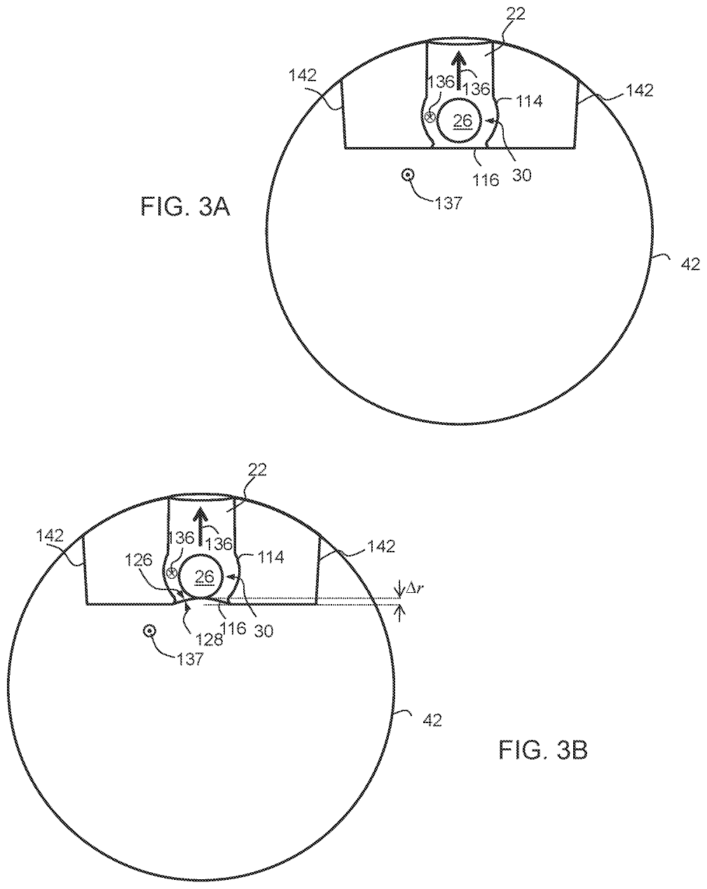

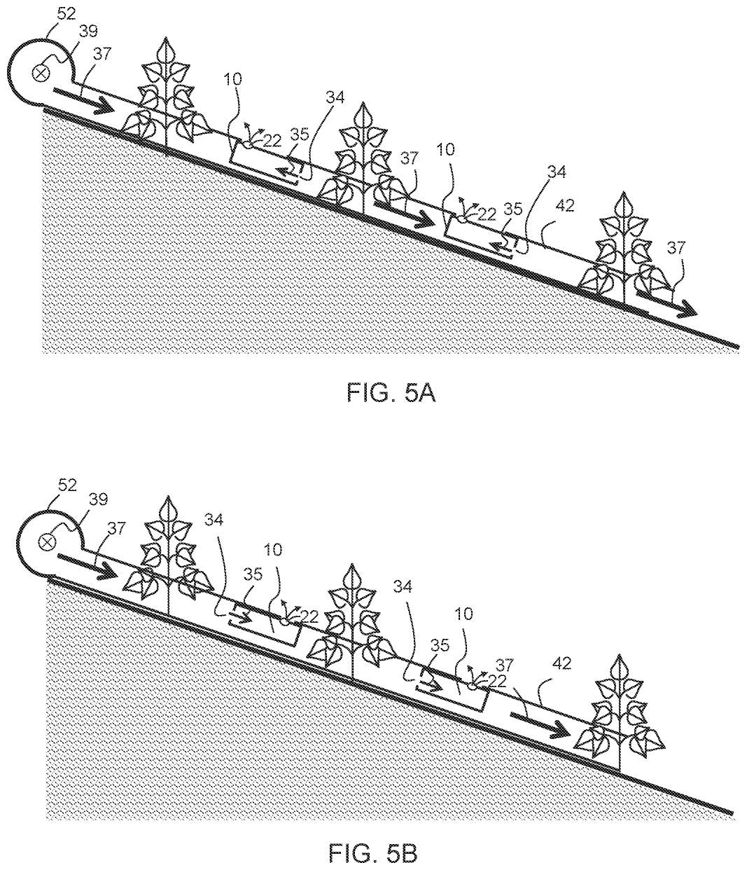

Use of antimicrobial coating 36 is different from conventional use of copper in irrigation systems in that in conventional irrigation systems the copper is mixed within the material from which the dripper is formed. The Inventors discovered that such a mixing is disadvantageous because it prevents the copper from migrating to surfaces in contact with the water, and therefore only a small portion of the copper is effective. Another advantage of using an antimicrobial coating which is a partially melted powder, is that the surface area of the particles is significantly larger than the surface area of the particles is significantly larger than the surface area of the copper when mixed within the material from which the dripper is formed. An additional advantage of the antimicrobial coating 36 is that it is applied at the inlet 34 of dripper 10. This allows coating 36 to reduce or inhibit accumulation of biofilm also within the pipe at which dripper 10 is deployed (see pipe 42 in FIGS. 3A, 3B, 5A, 5B), and not only within the dripper.

Dripper 10 may comprise antimicrobial coating 36 also at the outlet 22 of dripper 10, for reducing or inhibiting penetration of roots into the dripper. However, this need not necessarily be the case, since in some embodiments dripper 10 may antimicrobial coating 36 at inlet 34 but not as outlet 22.

A typical length of internal elongated structure 26 is from about 50% to about 120% of the length of structure 12.

A typical diameter of internal elongated structure 26 is from about 50% to about 95% of the diameter of bore 14, and from about 90% to about 99.99% of the diameter of bore 18.

Antimicrobial coating 36 can be applied in more than one way. In some embodiments of the present invention a process known as “cold spraying” is employed. In these embodiments a powder loaded gas stream is directed towards the surface of dripper 10 on which it is desired to apply the antimicrobial coating 36, for example, the surface of face 35. The powder comprises particles of an antimicrobial material such as, but not limited to, an inorganic antimicrobial material, e.g., a metallic antimicrobial material. Thus, for example, the powder can be a copper powder, or a powder which comprises any other of the aforementioned metals, metal halides, and/or metal salts.

The powder loaded gas stream produces on the surface of dripper 10 (e.g., the surface of face 35) a deposit that is built up from the powder material. Typically, in cold spraying the powder is not significantly melted. In some embodiments of the present invention the powder loaded gas stream is directed by means of a nozzle that is scanned across the surface of dripper 10 (e.g., the surface of face 35) so as to provide a uniform deposit. The gas stream can be a supersonic gas stream, a sonic gas stream, or a subsonic gas stream.

In some embodiments of the present invention a process known as “thermal spraying” is employed. Thermal spraying encompasses a number of different processes, all of which are contemplated according to some embodiments of the present invention. Generally, the aforementioned antimicrobial powder material is heated and subsequently atomized and projected toward the surface of the dripper 10 (e.g., the surface of face 35). Upon striking the surface, the particles of the heated powder deform to build up the coating. The powder can be heated by plasma, by electrical arc, by combustion flame, by detonation, by light, by induction, and the like. The present embodiments thus contemplate any type of thermal spraying, including, without limitation, flame spraying, electric arc spraying, plasma spraying, detonation spraying, laser spraying, and induction spraying.

In some embodiments of the present invention a process known as “dip coating” is employed. In this process, the surface of dripper 10 at which antimicrobial coating 36 is to be applied (e.g., the surface of face 35) is immersed in antimicrobial material which is in a melted or partially melted state. For example, a bath containing a powder which can be either a pure antimicrobial material (e.g., pure copper) or that comprises the antimicrobial material, can be heated by heating coils, heating rods, gas jets, induction heating, radiation heating or the like, to form a molten or partially molten substance and the surface of dripper 10 (e.g., the surface of face 35) can be brought to contact the molten or partially molten substance.

In any of the above embodiments, following the application of the antimicrobial material onto the surface of dripper 10, a cleaning process is optionally and preferably executed to remove residual traces of the antimicrobial coating material from pathway 30, and optionally and preferably, but not necessarily, from the immediate periphery of inlet 34 (e.g., at a distance of a few millimeters from inlet 34). The advantage of this operation is that it ensures that pathway 30 is free of obstacles. The cleaning process is preferably mechanical, so as to clean pathway 30, while maintaining the coating 36 on the surface of dripper 10 (e.g., the surface of face 35). However, a selective chemical cleaning process is also contemplated in some embodiments of the present invention.

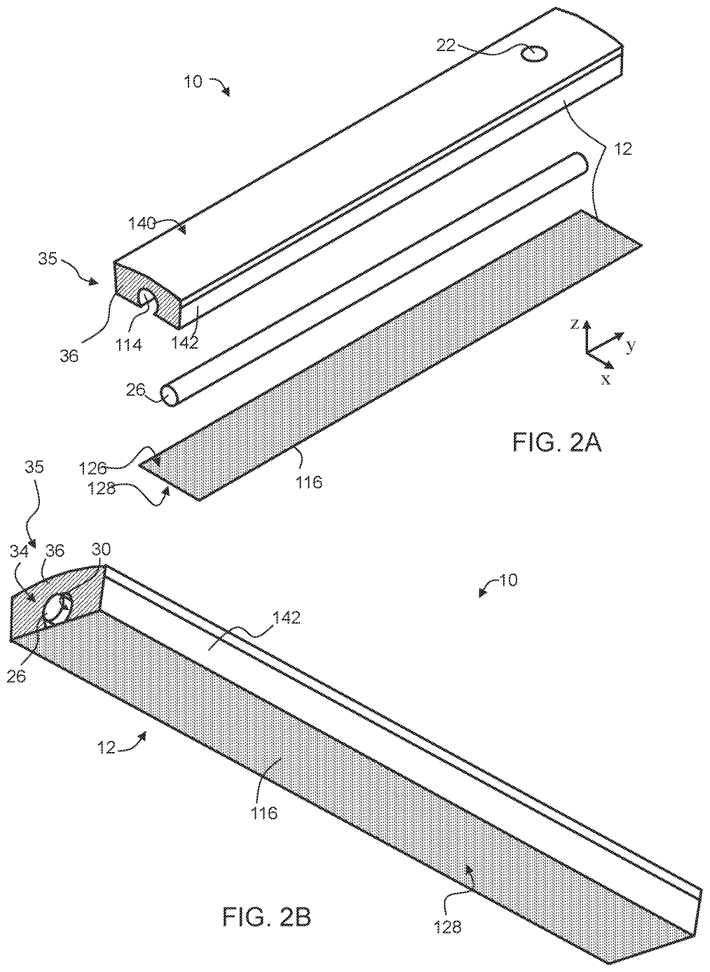

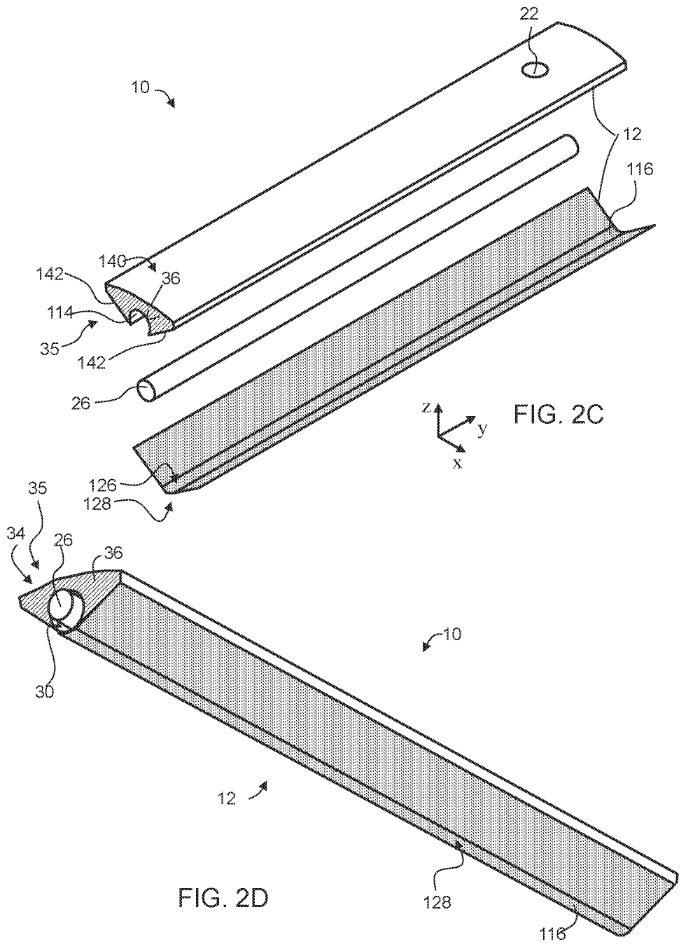

Additional shapes and configurations of dripper 10 in which antimicrobial coating 36 can be used according to some embodiments of the present invention, are schematically illustrated in FIGS. 2A-D and 4A-B. With reference to FIGS. 2A-D, perspective exploded views of irrigation dripper 10 are illustrated in FIGS. 2A and 2C, and perspective assembled views of irrigation dripper 10 are illustrated in FIGS. 2B and 2D. In the present embodiments, dripper 10 comprises an external elongated hollow structure 12 having a rigid wall 114 and optionally and preferably, but not necessarily, a flexible wall 116, and an internal elongated structure 26 introduced into external structure 12 to form pathway 30 for a flow of liquid (e.g., water) between internal structure 26 and walls 114 and 116.

In the schematic illustrations of FIGS. 2A-D, the volume defined by rigid wall 114 has a shape of a cylindrical segment, which is the solid cut from a cylinder by a plane parallel to the cylinder's longitudinal axis. However, this need not necessarily be the case, since, for some applications, it may not be necessary for rigid wall 114 to define a volume having such a shape. For example, rigid wall 114 can define a volume having the shape of a prism (e.g., a triangular prism, a parallelepiped, a square cuboid, a rectangular cuboid etc.).

Internal elongated structure 26 is optionally and preferably non-hollow. For example, structure 26 can be in the form of a rod. The rod can have any shape, such as, but not limited to, a cylinder or a prism (e.g., a triangular prism, a parallelepiped, a square cuboid, a rectangular cuboid etc.). Preferably, the shape of structure 26 is compatible (e.g., the same or similar, except with reduced transverse dimension) as the shape of the volume defined by the rigid wall 114.

Irrespectively of the shape of rigid wall 114, pathway 30 is optionally and preferably peripheral with respect to internal structure 26, and allows water to flow at a plurality of directions at any point along a length of dripper 10. This is advantageous because it reduces the likelihood for occlusion. Specifically, when an obstacle, such as a solid particle or an air bubble is trapped between internal structure 26 and one of the walls of external hollow structure 12, there are several alternative paths within pathway 30 allowing the liquid to bypass the obstacle so that pathway 30 is not completely blocked by the obstacle, and there is no clogging. Preferably, pathway 30 forms at least a two-dimensional surface within dripper 10.

Dripper 10 comprises an inlet 34 for providing liquid (e.g., water) to pathway 30, and an outlet 22 on external structure 12 for allowing the liquid to drip out of pathway 30. The dripper 10 shown in FIGS. 2A-D also comprises antimicrobial coating 36 on face 35 of external elongated hollow structure 12 in which inlet 34 is formed, as further detailed hereinabove.

Outlet 22 is shown in FIGS. 2A-D as circular, but other shapes for outlet 22 (e.g., oval, polygonal) are also contemplated. The diameter of the inlet 34 is preferably from about 50 μm to about 5000 μm. The diameter of outlet 22 is optionally and preferably the same, or approximately the same, as the diameter of pathway 30. A Cartesian coordinate system is shown in FIGS. 1A and 1C. The direction along internal structure 26 is referred to herein as the longitudinal direction y, and the direction perpendicular to the longitudinal direction y and to the direction z defined by outlet 22 is referred to as the transverse direction x.

The flexible wall 116 serves as a flow regulating member of dripper 10. This will be explained with reference to FIGS. 3A and 3B, which are cross-sectional schematic illustrations of dripper 10 within pipe 42, in a plane perpendicular to the longitudinal axis of pipe 42 (perpendicular to the flow in the pipe), and passing through the outlet 22 of dripper 10. The flow of liquid in pipe 42 is illustrated as circled dot 137 which represent a direction out of the plane of the drawings, and flow of liquid in pathway 30 of dripper 10 is illustrated as circled crosses which represent a direction into the plane of the drawings. The ordinarily skilled person, provided with the details in this disclosure would know how to adjust FIGS. 3A and 3B to the case in which the flow of liquid in pipe 42 and the flow of liquid in pathway 30 of dripper 10 are generally along the same direction.

The flow 136 of liquid in outlet 22 of dripper 10 is generally perpendicular to the flow in pathway 30 (upwards, in FIGS. 3A and 3B), and is illustrated by an arrow. At locations along pipe 42 at which there is no pressure drop on flexible wall 116, flexible wall 116 can assume a generally flat shape along the transverse direction x, as illustrated in FIG. 3A, or it can be curved outwardly (not shown, see FIG. 2D). FIG. 3B illustrates a location along pipe 42 at which there is a pressure drop on flexible wall 116. In a typical scenario of a pressure drop, the liquid pressure at the outer side 128 of wall 116 is higher than the liquid pressure at the inner side 126 of wall 116, in which case wall 116 is curved inwardly and partially restricts pathway 30, reducing the flow in pathway 30 and through outlet 22.

The curvature of wall 116 is proportional to the pressure drop across wall 116 ensuring that the extent of restriction in pathway 30 is inversely proportional to this pressure drop. Thus, dripper 10 is a flow regulated dripper. In some cases the liquid pressure upstream pipe 42 is higher and gradually decreases downstream pipe 42, this is a typical situation when pipe 42 is not inclined. In other cases, the liquid pressure along pipe 42 is non-monotonic (e.g., reaching a minimum at one or more locations along the pipe). This is a typical situation when pipe 42 is inclined. By providing pipe 42 with a plurality of flow regulated drippers like dripper 10, the pathways 30 of drippers are less restricted at locations in which the liquid pressure in the pipe is lower than at locations in which the liquid pressure in the pipe is higher, ensuring a generally uniform flow rate (e.g., with flow rate variations of less than 30% or less than 20% or less than 10%) at the outlets 22 of the drippers.

Flexible wall 116 can be embodied in more than one way. Preferably, flexible wall 116 is made of the same material as the rigid wall 114 of the external structure 12. In some embodiments of the present invention, wall 116 is in the form of a membrane attached to rigid wall 114, as illustrated in FIGS. 2A-D. The membrane can extend along the entire length of dripper 10 (along the longitudinal direction y), or along a portion of its length. The membrane can be made of any flexible material, and is preferably non-permeable to water. In some embodiments of the present invention the membrane is flexible but not elastic, and in some embodiments of the present invention the membrane is flexible and elastic. Representative example of materials suitable for the membrane include, without limitation, elastomeric material, rubber, polyvinyl chloride, and polyurethane.

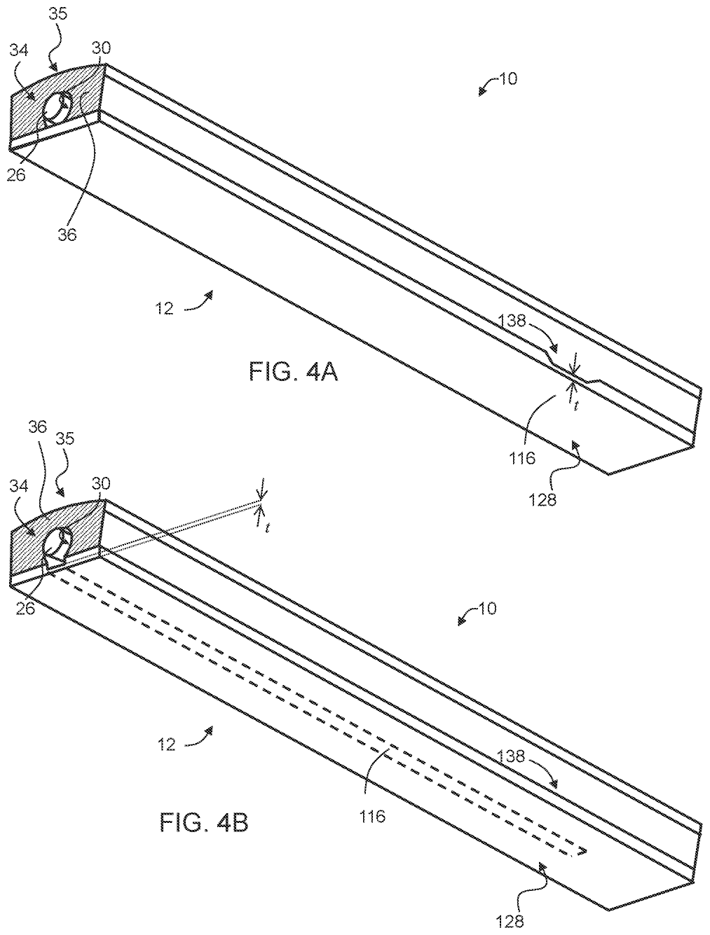

Flexible wall 116 can, in some embodiments of the present invention, be made of the same material as rigid wall 114 except at a smaller thickness. A representative example of these embodiments is illustrated in FIGS. 4A and 4B, which also show antimicrobial coating 36 on face 35 of external elongated hollow structure 12 in which inlet 34 is formed, as further detailed hereinabove.

The smaller thickness t can be realized at one or more discrete regions 138 along the length of pathway 30, as illustrated in FIG. 4A, or to extend along the entire length of pathway 30, as illustrated in FIG. 4B. In some embodiments of the present invention, the smaller thickness t is realized only at the vicinity of the lumen of hollow structure 12.

A typical thickness for flexible wall 116, in any of the embodiments described herein, is from about 20 microns to about 200 microns, more preferably from about 50 microns to about 150 microns.

The size and the material of flexible wall 116 are optionally and preferably both selected such that flexible wall 116 exhibits a sufficiently high deformation in response to a sufficiently low pressure difference ΔP between the inner side 126 and outer side 128 of wall 116. The deformation of wall 116 can be parameterized by the maximal displacement Δr of wall 116 inwardly (see FIG. 3B). Typical values for ΔP are at most 400 cmH₂O or at most 200 cmH₂O or at most 100 cmH₂O or at most 50 cmH₂O or at most 25 cmH₂O or at most 10 cmH₂O or at most 5 cmH₂O or at most 2.5 cmH₂O, and typical values of Ar are at least 10 μm or at least 20 μm or at least 40 μm or at least 80 μm or at least 100 μm.

Generally, flexible wall 116 can have any shape in the absence of a pressure difference ΔP between its inner 126 and outer 128 sides. In the schematic illustration shown in FIGS. 2A and 2B, flexible wall 116 is substantially planar (e.g., with deviation of less than 10% from planarity) in the absence of a pressure drop thereacross. In the schematic illustration shown in FIGS. 2A and 2B, flexible wall 116 is substantially planar (e.g., with deviation of less than 10% from planarity) in the absence of a pressure drop thereacross. This can be achieved, for example, by providing the outer surface 140 of rigid wall 114 with two generally planar structures 142 intersecting with flexible wall 116. Structures 142 are typically generally parallel to each other (e.g., with deviation of less than 10° from parallelism).

In the schematic illustration shown in FIGS. 2C and 2D, flexible wall 116 is curved in the absence of a pressure drop thereacross. This can be achieved, for example, by providing an outer surface 140 of rigid wall 114 which is tapered towards flexible wall 116. For example, outer surface 140 can have two generally planar structures 142, at an angle to each other, intersecting with flexible wall 116.

A typical use of dippers 10 is schematically illustrated in FIGS. 5A and 5B. In use, one or more of dippers 10 are introduced into an irrigation dripping pipe 42. The dripping pipe 42 is deployed in a field and a liquid 37 (e.g., water) is introduced into the pipe 42. The liquid enters the dipper 10 through the inlet 34 at the proximal end of the pathway 30 between bore 14 and internal elongated structure 26 (see, e.g., FIG. 1A) and drips out of dripper 10 via one or more of outlets 22.

Liquid 37 is typically introduced from a distributing line 52 (aligned in FIGS. 5A and 5B perpendicular to the plane of the drawing) or directly from a liquid source (not shown). The flow 39 of liquid in distributing line 52 is illustrated as circled crosses which represent a direction into the plane of the drawings. FIG. 5A illustrates a preferred embodiment in which the inlet 34 is downstream with respect to the flow 37 outside the dripper, so that the inflow 35 of liquid (e.g., water) through inlet 34 is opposite to the flow 37 in pipe 42 outside the dripper. In experiments performed by the Inventors it was unexpectedly discovered that such a construction provides a more efficient dripping with less clogging, and significantly reduces the maintenance effort required to maintain dripping. Yet, configurations in which the inlet 34 is upstream with respect to the flow outside the dripper (namely irrigation dripping pipes in which the inflow into the dripper is generally along the direction of the flow in the pipe outside the dripper) are also contemplated, and are illustrated in FIG. 5B.

As used herein the term “about” refers to +10%

The terms “comprises”. “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An irrigation dripper comprising a generally straight water pathway for allowing a two-dimensional or a three-dimensional flow of water therein, an inlet for providing water to said pathway, an outlet for allowing water to drip out of said pathway at an angle to said pathway, and an antimicrobial coating at least partially surrounding said inlet.

2. The irrigation dripper according to claim 1, comprising:
an external elongated hollow structure enclosing an internal elongated structure, wherein said water pathway surrounds said internal structure in a space between said structures, wherein said inlet is on a face of said external structure, said outlet is on said external structure, and said antimicrobial coating is on said face of said external elongated hollow structure, but not within said pathway.

3. The irrigation dripper according to claim 1, comprising:
an external elongated hollow structure having a rigid wall and a flexible wall, and an internal elongated structure introduced into said external structure, wherein said pathway is formed between said internal structure and said walls, said inlet is on a face of said external structure, said outlet is on said external structure at said rigid wall, and said antimicrobial coating is on said face of said external elongated hollow structure, but not within said pathway.

4. The irrigation dripper according to claim 3, wherein said flexible wall is generally planar in the absence of pressure difference between an inner side and an outer side thereof.

5. The irrigation dripper according to claim 3, wherein said flexible wall is curved in the absence of pressure difference between an inner side and an outer side thereof.

6. The irrigation dripper according to claim 1, wherein said antimicrobial coating is inorganic.

7. The irrigation dripper according to claim 6, wherein said antimicrobial coating is metallic.

8. (canceled)

9. The irrigation dripper according to claim 1, wherein said antimicrobial coating comprises copper.

10. (canceled)

11. The irrigation dripper according to claim 1, wherein said antimicrobial coating comprises a partially melted powder.

12. (canceled)

13. The irrigation dripper according to claim 11, wherein said powder comprises particles less than 80 microns in diameter.

14. (canceled)

15. The irrigation dripper according to claim 13, wherein at least 99% of said particles are less than 80 microns in diameter.

16. (canceled)

17. The irrigation dripper according to claim 15, wherein at least 95% of said particles are less than 40 microns in diameter.

18. (canceled)

19. The irrigation dripper according to claim 1, wherein said face of said external elongated hollow structure is spray coated by said antimicrobial coating.

20. (canceled)

21. The irrigation dripper according to claim 19, wherein said spray coating is cold spray coating.

22. (canceled)

23. The irrigation dripper according to claim 19, wherein said spray coating is thermal spray coating.

24. (canceled)

25. The irrigation dripper according to claim 1, wherein said face of said external elongated hollow structure is dip coated by said antimicrobial coating.

26. (canceled)

27. An irrigation dripping pipe, comprising an irrigation pipe provided with a plurality of drippers, wherein at least one of said drippers is the irrigation dripper according to claim 1.

28. (canceled)

29. The irrigation dripping pipe according to claim 27, wherein said irrigation pipe has a first end connectable to a water source or a water distribution line, and second end distal to said first end, and wherein for at least one of said drippers, said inlet is facing said second end such that an inflow of water into said at least one dripper is opposite to a flow of water in said irrigation pipe.

30. (canceled)

31. A method of irrigation, the method comprising deploying the irrigation dripping pipe according to claim 27 in a field, and supplying water to the irrigation dripping pipe.

32. (canceled)
